(19) United States
(12) Patent Application Publication
(10) Pub. No.: US 2026/0202432 A1
(43) Pub. Date: Jul. 16, 2026

(54) FLEXIBLE MOLECULAR SYNDROMIC PCR WORKFLOWS

(71) Applicant: Siemens Healthcare Diagnostics Inc., Tarrytown, NY (US)

(72) Inventor: Guido Hennig, Köln (DE)

(73) Assignee: Siemens Healthcare Diagnostics Inc., Tarrytown, NY (US)

(21) Appl. No.: 19/136,179

(22) PCT Filed: Oct. 24, 2023
(86) PCT No.: PCT/US2023/077604

§ 371 Date: Jun. 5, 2025

Related U.S. Application Data
(60) Provisional application No. 63/476,210, filed on Dec. 20, 2022.

(51) Int. Cl. G01N 35/00; G01N 21/64

(52) U.S. Cl. CPC G01N 35/0092; G01N 21/6428; G01N 2035/00346

(57) ABSTRACT

The present disclosure provides workflows, methods, and systems for performing syndromic polymerase chain reaction (PCR) testing with random and on demand access to both patient samples and assays. The embodiments described herein enable flexible and customized testing of multiple, individual targets for different individual patients. The present embodiments also provide for eluate harvesting and storage for parallel and/or reflex testing. The methods and systems in the present disclosure may enable greater flexibility, faster turnaround times and higher efficiency with lower costs for PCR testing.

### FIELD

The present disclosure relates generally to polymerase chain reaction (PCR) testing workflows, and in particular to real-time automated PCR testing workflows with random access to both samples and assays.

### BACKGROUND

The polymerase chain reaction (PCR) is a widely used laboratory technique to amplify copies of DNA fragments for a range of applications including genetic testing, identification of pathogens, diagnosis of diseases, and forensics. The basic PCR reaction involves repeated thermal cycling for alternating between DNA melting at elevated temperatures and DNA replication using polymerase enzymes, resulting in exponential amplification of DNA copies with each cycle. Variations of PCR include real-time quantitative PCR (qPCR), which allows precise quantification of DNA copies, and reverse transcription PCR (RT-PCR), which allows the amount of RNA to be measured.

Real-time quantitative PCR (qPCR) is a dominant technology in the in vitro diagnostics (IVD) molecular testing field (Yang and Rothman, Lancet Infect. Dis., 2004, 4(6), 337-348). In such PCR systems, highly automated workflows enable the reduction of labor, time, and overall costs (Mahony et al., J. Clin. Microbiol. 2009, 47 (9), 2812-2817). Currently, PCR platforms are highly automated in one of two primary workflows: (1) batch processes with separate extraction of samples and subsequent PCR analysis; or (2) integrated, random access processes with automated workflows, which can use either low volume cartridges or high volume, large footprint analyzers.

Furthermore, the molecular IVD market increasingly uses syndromic molecular testing, which combines (i.e., multiplexes) several targets in one PCR reaction (Dumkow et al., J. Antimicrob. Chemother. 2021, 76, Suppl. 3, iii4-iii11). Syndromic testing has significant clinical utility, and can be used to detect one or multiple pathogens (e.g., fungi, viruses, bacteria, or parasites) in one sample and one workflow to manage infectious diseases.

However, there are several limitations of current molecular syndromic testing workflows and typical molecular platforms. Clinical samples often only have enough volume to be combined with one master mix or PCR kit, so they need to be diluted to allow testing for a large number of requested targets, which results in reduced sensitivity. Limited sample volume is particularly a concern for certain samples that may be more challenging to collect, such as cerebrospinal fluid (CSF) or samples obtained from infants or young children. Furthermore, these diluted samples are processed in multiple independent extraction/detection workflows, which increase requirements for labor, time, and costs.

Another drawback is that leftover eluates from primary extractions are typically not automatically harvested or stored. Thus, clinical samples often need to be re-extracted, or even worse, re-collected from patients when more follow-up testing (i.e., reflex testing) is required after a first test result is reported. Any additional re-extraction or re-collecting of samples adds processing time, labor, and cost, and also may cause further patient discomfort and inconvenience.

Furthermore, syndromic testing workflows often use cartridge-based systems that have fixed compositions of target panels with up to 50 targets or assays that must be tested together in combination, even if they are not all needed. Lab operators, physicians, and health insurance providers are pushing for diagnostic suppliers to provide “unlocked” solutions that can be more specifically selected for clinical needs. In general, current PCR platforms are not designed or programmed to allow flexible combinations of workflow features.

### SUMMARY

The present disclosure provides workflows for flexible, random access syndromic PCR testing. The present disclosure also includes methods to provide combinations of independent master mixes that can be tested on a given eluate, eluate harvesting and storage for parallel and/or reflex testing, random access to patient samples, and random access to PCR assays or master mixes. By providing random access to both patient samples and PCR assays, medical practitioners can request customized and specific testing for multiple, individual targets (e.g., different viruses, bacteria, fungi, and other pathogens) for different patients in primary and reflex testing workflows. The embodiments described in the present disclosure also provide for the storage of samples and eluates that may be used for reflex testing in response to initial test results, which may provide further test results without having to collect new patient samples. The methods and systems in the present disclosure may enable greater flexibility and efficiency for PCR testing. The combination of being able to choose both samples and PCR assays at will, providing both random access and on demand access to both samples and assays, may be termed a “pick-and-mix” PCR strategy or system, or may be termed a random access syndromic PCR strategy or system, according to the present disclosures and embodiments.

Advantages of the methods and systems described in the presented disclosure may include, for example, greater control and flexibility in choosing targets for PCR testing, less hands-on labor and processing time, faster turnaround times for obtaining test results, faster turnaround times for clinical reporting, lower costs, higher test sensitivity, eliminating the need for collecting additional patient samples, and generally improving patient care. Methods according to the present embodiments may include one or more treatment steps that include one or more suitable treatments, once a diagnosis has been made, as described herein.

In one aspect, the present embodiments are directed to an automated system for performing real-time polymerase chain reaction (PCR) assays with random access, including: a random access sample sub-system; a random access PCR assay sub-system; a PCR reaction sub-system; and a software and control system to program, control and run diagnostic workflows.

In some embodiments, the random access sample sub-system includes: a sample loading bay through which a plurality of patient samples are introduced into the automated system; a sample holding area adjacent to the sample loading bay; a lysis module adjacent to the sample holding area; a plurality of sample extraction slots adjacent to the sample holding area to extract nucleic acids from the plurality of patient samples; a temperature-controlled sample storage tower adjacent to the plurality of sample extraction slots to store the patient samples; an eluate harvest area; an eluate splitting mechanism; a temperature-controlled eluate storage tower to store eluates harvested in the eluate harvest area; and an automated transport module to move samples and eluates between each of the sample loading bay, the sample holding area, the sample extraction slots, the sample storage tower, the eluate splitting mechanism, the eluate harvest area, and the eluate storage tower.

In some embodiments, the random access PCR assay sub-system includes: an assay reagent and PCR master mix loading bay through which assay reagents and PCR master mixes are introduced into the automated system; a plurality of assay reagent storage slots adjacent to the assay reagent and PCR master mix loading bay; a plurality of PCR master mix storage slots adjacent to the assay reagent and PCR master mix loading bay; an automated assay transport module to transfer assays and master mixes between different components of the PCR assay sub-system; and an automated multichannel pipettor.

In some embodiments, the PCR reaction sub-system includes: a PCR setup area to combine and prepare PCR testing components; a PCR testing area adjacent to the PCR setup area; and an automated multichannel pipettor.

In some embodiments, the PCR testing area includes: a plurality of centrifuge modules; a plurality of real-time thermal cycler modules; and a PCR well sealing unit.

In some embodiments, the software and control system includes: a computer processor and a memory system; a communications connection; a laboratory information system (LIS); and a digital user interface (UI), wherein the computer processor executes programs stored in the memory system to select samples and assays for conducting PCR testing and to report PCR test results, wherein the computer processor controls the digital UI to interact with a user to program and run customized testing workflows, wherein the communications connection receives instructions for conducting PCR testing and transmits PCR test results, and wherein the computer processor, the memory system, the communications connection, and the digital user interface are all electronically coupled.

In some embodiments, the communications connection includes a wired internet connection and/or a wireless internet connection, and wherein the communications connection receives test instructions from a medical provider and transmits test results to the medical provider.

In some embodiments, the automated system further includes: a software-based user interface; and diagnostic algorithms to assess test results and select reflex testing.

In another aspect, the present embodiments are directed to a method for performing random access polymerase chain reaction (PCR) testing by an automated system, including: receiving, by a laboratory information system (LIS) in the automated system, PCR testing instructions from a medical provider; preparing one or more patient test samples as instructed by the testing instructions; preparing one or more master mix portions from subcomponents as instructed by the testing instructions; performing one or more PCR tests using a combined test volume including the one or more patient test sample and the one or more master mix portions; obtaining results from the one or more PCR tests; and communicating the results.

In some embodiments, preparing the one or more patient test samples includes: selecting a patient sample obtained from a patient; extracting nucleic acids from the patient sample; preparing one or more eluates to form the one or more patient test samples; and storing additional eluates in an eluate storage area of the automated system.

In some embodiments, preparing one or more master mix portions includes: selecting one or more target-specific master mixes from a plurality of PCR master mixes stored in the automated system, the one or more master mix portions being determined from the PCR testing instructions; obtaining one or more quantities of the one or more target-specific master mixes using an automated mechanism; and forming the one or more master mix portions by combining the following: one or more quantities of the one or more target-specific master mixes; and one or more other reagents selected from the group consisting of PCR enzymes, PCR buffers, and control samples.

In some embodiments, performing one or more PCR tests includes: combining and sealing the one or more patient test samples and one or more master mix portions to form one or more test volumes; transferring the one or more test volumes to one or more thermal cyclers; and operating the one or more thermal cyclers as instructed by a thermal program provided by the LIS based on the testing instructions.

In some embodiments, obtaining results from the one or more PCR tests includes: measuring one or more optical signals from the one or more test volumes during the one or more PCR tests; and storing the one or more optical signals as one or more test results in a memory system of the automated system, wherein the one or more optical signals include one or more fluorescent signals.

In some embodiments, communicating the results includes: for each target tested in the one or more master mix portions, checking whether the target was requested in the test instructions from the medical provider; if the target was requested, displaying the result to an operator of the automated system and transmitting the result to the medical provider; and if the target was not requested, continuing to store the test result in the memory system of the automated system.

In some embodiments, the method prior to preparing the one or more patient test samples includes: applying a barcode to each of a plurality of biological samples obtained from patients; loading each of the plurality of biological samples into the automated system; and processing each of the plurality of biological samples by loading order or by a prioritization request received by the LIS.

In some embodiments, the method further includes receiving reflex testing instructions from the medical provider after communicating the results to the medical provider.

In some embodiments, the method further includes the following steps to conduct reflex testing: checking whether a reflex test target has previously been tested and has been stored in memory; displaying and communicating the previously tested result if the result is available; obtaining a sample eluate from previously stored sample eluates; preparing one or more master mix portions; performing one or more reflex PCR tests as instructed by the reflex testing instructions; and communicating results from the one or more reflex PCR tests.

In another aspect, the present embodiments are directed to a method of a user interacting with a random access PCR test system to perform a PCR test, including: (a) selecting, by the user, a patient sample using a user interface (UI) associated with the random access PCR test system; (b) viewing on the UI, by the user, instructions transmitted by a medical provider to a library information system (LIS); (c) selecting via the UI, by the user, testing parameters for one or more PCR tests, wherein the testing parameters are based on the instructions; (d) preparing, by the PCR test system, the patient sample and one or more master mix portions determined by the instructions so that the patient sample and the one or more master mix portions are combined for PCR testing; (e) running, by the PCR test system, one or more PCR tests; (f) displaying, by the PCR test system, the result of the one or more PCR tests on the UI; (g) selecting, by the user using the UI, further reflex testing instructions and/or reporting the results to the medical provider; (h) displaying, by the PCR system on the UI, any requested results that may have been previously hidden; (i) preparing, by the PCR test system, a sample from a stored sample eluate from the same patient sample and one or more master mix portions as indicated by reflex testing instructions from step (g); and (j) running, by the PCR test system, one or more PCR tests as indicated by reflex testing instructions from step (g).

In some embodiments, selecting test parameters includes: adding one or more master mixes or targets corresponding to the instructions; setting sample priority level; deciding on storage or harvesting of eluate; and deciding on reflex testing algorithms and options.

In some embodiments, running one or more PCR tests includes: (a) heating a sample and one or more master mixes to a denaturation temperature at a first heating rate and holding at the denaturation temperature for a first time period; (b) cooling the sample and the one or more master mixes to an annealing temperature at a first cooling rate and holding at the annealing temperature for a second time period; (c) heating the sample and the one or more master mixes to an extension temperature and holding at the extension temperature for a third time period; and (d) repeating steps (a)-(c) for a required number of cycles.

In some embodiments, the method further includes activating the sample via Taq polymerase heat activation prior to step (a).

In some embodiments, the method further includes performing a reverse transcriptase (RT) step for RNA targets prior to step (a).

### BRIEF DESCRIPTION OF THE DRAWING

The present teachings described herein will be more fully understood from the following description of various illustrative embodiments, when read together with the accompanying drawings. It should be understood that the drawings described below are for illustration purposes only and is not intended to limit the scope of the present teachings in any way.

FIG. 1 is a diagram summarizing two main conceptual parts of the “pick-and-mix” PCR strategy: random access and on demand access to both samples and reagents for assays, according to aspects of the present embodiments.

FIG. 2 is a diagram showing an example of a menu screen with core disease or application areas (left), and products and panels found in a traditional automated PCR system (right), with multiple pathogens combined into particular testing panels. Each product or panel can represent between about 1 and 20 pathogens.

FIG. 3 is a diagram showing an example of a menu screen with core disease or application areas (left), and modular products represented by single master mixes in a pick-and-mix PCR strategy system (right), with the option to choose and optionally combine single master mixes, each representing one to several targets, according to aspects of the present embodiments.

FIG. 4 is a flow chart diagram showing the movement of master mixes in a master mix pathway (left), and the movement of samples and eluates in a sample pathway (right) in a pick-and-mix strategy system, and both master mixes and sample eluates coming together in multiple PCR reactions (center), according to aspects of the present embodiments.

FIG. 5 is a flow chart diagram showing a method for performing an analysis using a pick-and-mix strategy PCR system, according to aspects of the present embodiments.

FIG. 6 is a diagram showing main components of a pick-and-mix PCR system, how they relate to each other, their constituent sub-components, and how some sub-components relate to each other, according to aspects of the present embodiments.

FIG. 7 is a table showing examples of different types of multi-target mixes, single-target mixes, calibrators, control samples, enzymes, and buffers that may be used in a PCR system, according to aspects of the present embodiments.

FIG. 8 includes two tables showing two examples of PCR tests and reagents to be combined in a conventional PCR testing system, where multiple targets must be tested at the same time.

FIG. 9 includes three tables showing three examples of PCR tests and reagents to be combined in a pick-and-mix PCR testing system, where a combination of single-target and multi-target mixes can be chosen, according to aspects of the present embodiments.

FIG. 10 is a flow chart diagram showing an example of a workflow and time estimate for a conventional PCR testing system. After an initial testing stage, taking new patient samples is required if reflex testing is ordered.

FIG. 11 is a flow chart diagram showing an example of a workflow and time estimate for a pick-and-mix PCR system. After an initial testing stage, stored sample eluates can be used immediately for reflex testing, according to aspects of the present embodiments.

FIG. 12 is a flow chart diagram showing a method for a user to interact with a user interface (UI) to provide inputs to, and receive outputs from, a software program controlling a pick-and-mix PCR testing system, according to aspects of the present embodiments.

### DEFINITIONS

About, Approximately: As used herein, the terms “about” and “approximately” as used in reference to a value, refers to a value that is similar, in context to the referenced value. In general, those skilled in the art, familiar with the context, will appreciate the relevant degree of variance encompassed by “about” and “approximately” in that context. For example, in some embodiments, the terms “about” and “approximately” may encompass a range of values that within 25%, 20%, 19%, 18%, 17%, 16%, 15%, 14%, 13%, 12%, 11%, 10%, 9%, 8%, 7%, 6%, 5%, 4%, 3%, 2%, 1%, or less of the referred value.

Assay: As used herein, the term “assay” refers to a laboratory test to measure or assess the presence or amount of a target molecule. For example, a PCR assay may be used to quantify the amount of a particular DNA sequence in a liquid sample.

Eluate: As used herein, the term “eluate” refers to the DNA extracted from a patient sample by elution, which is then used in a PCR reaction. In typical automated PCR systems, the eluate may be about 20 to 100 μL in volume.

Eluate splitting: As used herein, the term “eluate splitting” refers to dividing a volume of eluate into smaller eluate portions that may be each about 10% to 20% of the initial eluate volume.

Enzyme: As used herein, the term “enzyme” refers to an enzyme used during a PCR reaction. For example, a polymerase enzyme may be used to polymerize a DNA strand; a reverse transcriptase enzyme may be used convert an RNA sequence to its complementary DNA (cDNA) sequence, during reverse-transcription PCR. In some embodiments, a PCR enzyme may be a DNA polymerase. In some embodiments, a reverse transcription (RT)-PCR enzyme may be a reverse transcriptase.

Internal control (IC): As used herein, the term “internal control (IC)” refers to a particular primer and probe pair to detect a certain known pathogen. The IC may be spiked into a sample to verify proper operation of a PCR testing system and assay. In some embodiments, the internal control may be extra or non-extracted.

Laboratory information system (LIS): As used herein, the term “laboratory information system (LIS)” (also “laboratory information management system (LIMS)” or “laboratory management system (LMS)”) refers to a software system that processes information related to patient samples and testing requests, coordinates testing and analysis workflows, and may communicate with physicians, clinics, and electronic health record (EHR) systems.

Master mix or mastermix or MMx: As used herein, the term “master mix” refers to a prepared mixture (which may be prepared elsewhere off the main PCR system or prepared on the PCR system using loaded subcomponents) that includes all reagents (dNTPs, buffer, MgCl₂, primers and probes, etc.), enzyme buffers, and enzymes (i.e., DNA polymerase, reverse transcriptase) that are combined on the system with an extracted nucleic acid (DNA, RNA or both) sample to perform a singleplex or multiplex PCR and/or RT-PCR assay. The master mix may be loaded as one complete component on the system in liquid format or dry format (i.e., to be reconstituted with water or buffer before use) and only lacks the extracted nucleic acid added on the system. For stability and performance reasons, certain sub-components of the master mix can be loaded individually, can be ready to use on the system in dry or liquid format, and are prepared at the correct concentrations and quantities to generate the final ready-to-use master mix.

Medical provider or healthcare provider or medical practitioner or healthcare practitioner: As used herein, the terms “medical provider” or “healthcare provider” or “medical practitioner” or “healthcare practitioner” may refer interchangeably to an individual health professional or a health facility organization that is involved in providing diagnosis, treatment, and care to patients. Individual providers or practitioners may include a physician, a doctor, a nurse practitioner, a surgeon, a radiologist, an obstetrician, a dentist, a pediatrician, etc. Heath facilities may include clinics, hospitals, hospital networks, health systems, medical groups, etc.

Negative control: As used herein, the term “negative control” refers to a sample or representative sample matrix without the respective target(s) to be tested on the system, so that contamination of the system reagent components or of the system itself may be detected. In some embodiments, a negative control may be nuclease-free water (universal negative control which contains no targets at all).

On demand: As used herein, the term “on demand” refers to something that is available as soon as or whenever required or requested. Within the context of automated PCR testing, “on demand” may refer to the ability to readily request a particular PCR assay when requested by a medical provider. It may also indicate that a particular PCR assay is accessible by software and workflow planning.

Polymerase chain reaction (PCR), real-time quantitative PCR (qPCR), and reverse-transcriptase real-time quantitative PCR (RT-qPCR): As used herein, the term “polymerase chain reaction (PCR)” refers to a reaction and a laboratory technique for amplification of DNA copies. The term “real-time quantitative PCR (qPCR)” is a variation of PCR that monitors in real time the number of DNA copies generated. The term “reverse-transcriptase real-time quantitative PCR (RT-qPCR) refers to a PCR reaction for amplification of RNA copies. In some instances, use of the term PCR may imply applicability to PCR in general, qPCR, and/or RT-qPCR. The term “real-time” refers to continuous monitoring of fluorescence during thermal cycling for qualitative and quantitative analysis. Different fluorescent probes and monitoring technologies can be applied such as TaqMan probes, Scorpion probes, melting curve analysis with intercalating dyes, etc. Throughout the present disclosure, the general term PCR may include all the above techniques (PCR, qPCR, RT-PCR, and RT-qPCR).

Positive control: As used herein, the term “positive control” refers to a sample with particular nucleic acid sequences known to produce a certain result, which can be used to verify that the full workflow of extraction and PCR testing is operating properly.

Primer/probe mix (PP mix): As used herein, the term “primer/probe mix (PP mix)” refers to the combination of primers, which are DNA strands complementary to a sequence of interest, and probes, which are DNA oligonucleotides labeled with a fluorescent reporter molecule that bind downstream of the forward primer. During the polymerase-enabled step during a PCR reaction, the fluorescent reporter molecule is cleaved from the probe strand and released. The increase in cleaved fluorescent molecules with each PCR reaction cycle can be measured as a fluorescence signal. In the context of automated PCR testing, PP mixes are targeted for detecting particular pathogens.

Random access: As used herein, the term “random access” refers to the ability to access any element of a group (e.g., a sample, an assay, an extraction, or a control component) regardless of the position or sequence of the element. For example, random access to samples means that any sample may be selected at any time, and may be subjected to testing with a defined workflow, regardless of the order in which the sample was entered into the testing system. Random access also applies to accessing the eluate or eluate portions after the extraction process. For example, random access to assays means that any PCR assay component or full master mix may be selected to be performed, regardless of its relation to other assays that may be stored in the same system.

Reflex test: As used herein, the term “reflex test” refers to a diagnostic test that is performed after an initial test based on the results of the initial test. For example, the initial test may be inconclusive so that a second test is needed to find a diagnosis. For example, the initial test may provide a result that needs further testing to refine or confirm a finding. Reflex testing may generally be conducted using leftover portions of an extracted eluate from the same patient sample extraction or unused portions of an originally collected patient sample, or using a newly collected patient sample.

Sample: As used herein, the term “sample” refers to an aliquot of material collected or obtained from a patient for the purposes of performing a diagnostic test to ascertain the presence and/or quantity of a particular target such as a pathogen and/or an endogenous (sample containing) cellular human gene sequence. In some embodiments, a sample may be liquid, solid, or partially liquid and partially solid. Examples of samples may include blood, serum, saliva, nasal swabs, urine, cerebrospinal fluid, lymphatic fluid, tissue, or stool. In some embodiments, samples may be obtained or collected by extracting with a needle, cutting, scraping, secreting, washing, swabbing, etc. In the context of automated PCR systems, a patient sample may be typically about 50-1000 μL in volume and is preferably a liquid. In some embodiments, initial processing and/or pretreatment steps may be taken to make a sample suitable for PCR testing. In some embodiments, the term “sample” may also refer to a control sample, i.e., a negative control, a positive control, and/or an internal control or calibrator for external quantification of the target in a patient sample.

STAT testing: As used herein, the term “STAT testing” refers to Short Turn Around Testing (STAT), where an individual diagnostic test is performed without pre-scheduling and allows particular samples to be prioritized over samples which are scheduled at certain run times.

Syndromic testing: As used herein, the term “syndromic testing” refers to diagnostic testing that can test for multiple pathogens simultaneously, when there may be more than one pathogen that can cause overlapping symptoms and signs. A syndrome is a combination of symptoms and signs that tend to occur together and may suggest the presence of one or more infectious diseases. Syndromic testing may make use of pre-packaged panels that test for collections of targets or pathogens that result in similar syndromes.

Turnaround time (TAT): As used herein, the term “turnaround time (TAT)” may refer to a testing turnaround time. For example, in some contexts, the TAT may refer to the time between when a sample arrives at a testing site and/or is prepared for loading on a system and when a result is reported by the system. For example, in other contexts, TAT may also refer to the time between when a physician takes a patient sample and/or requests a diagnostic test and when the physician receives a result from the diagnostic test.

### DETAILED DESCRIPTION OF CERTAIN EMBODIMENTS

It is contemplated that methods, systems, and processes of the claimed invention encompass variations and adaptations developed using information from the embodiments described herein. Adaptation and/or modification of the methods, systems, and processes described herein may be performed, as contemplated by this description.

Throughout the description, where methods, systems, and processes are described as having, including, or comprising specific components, or where processes and methods are described as having, including, or comprising specific steps, it is contemplated that, additionally, there are systems of the present invention that consist essentially of, or consist of, the recited components, and that there are processes and methods according to the present invention that consist essentially of, or consist of, the recited steps.

It should be understood that, unless otherwise indicated, the order of steps or order for performing certain action may be immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

Documents are incorporated herein by reference as noted. Where there is any discrepancy in the meaning of a particular term, the meaning provided in the Definition section above is controlling.

Headers are provided for the convenience of the reader; the presence and/or placement of a header is not intended to limit the scope of the subject matter described herein.

### Overview of Random Access Syndromic PCR Strategy or Pick-and-Mix PCR Strategy

This section provides an overview of the underlying concepts in the present embodiments of a random access syndromic PCR strategy, which may also be called a pick-and-mix PCR strategy.

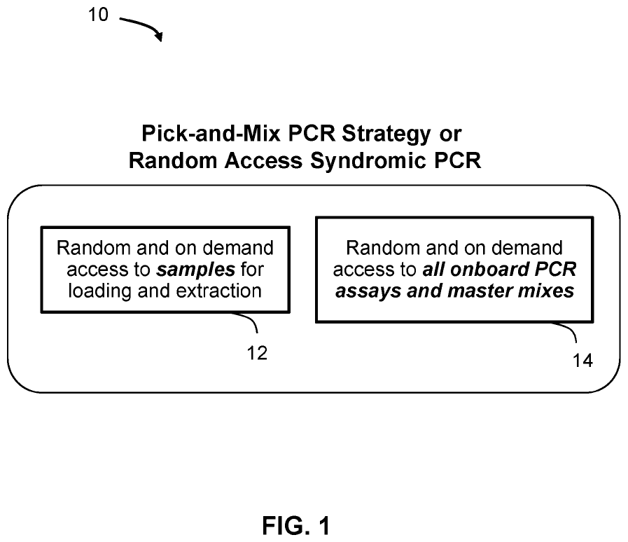

FIG. 1 is a diagram summarizing two main conceptual parts of the pick-and-mix PCR strategy 10 for use in an automated PCR testing system: random access and on demand access for samples for loading and extraction 12, and random access and on demand access to all onboard PCR assays and master mixes 14, according to aspects of the present embodiments. Random access means for samples that any patient sample that has been loaded, barcoded, and stored in the PCR system may be picked for testing regardless of the order in which the sample was initially loaded and regardless of its physical position in the storage area or relation to other patient samples in storage. On demand access for samples means that a sample may be requested and picked without delay and without regard for the order in which it was originally acquired or loaded into the testing system. Random access to samples means that any sample may be chosen for testing regardless of its location in the test system or its physical relationship to other stored patient samples. Having random access and on demand access to reagents means that any combination of reagents may be selected and combined to form custom PCR master mixes to test for any set of targets contained within the PCR system that are requested by clinicians. The combination of these features together for the pick-and-mix PCR strategy means that any patient sample loaded into the PCR system may be tested for a much wider range of targets, with faster turnaround times and greater flexibility and customization.

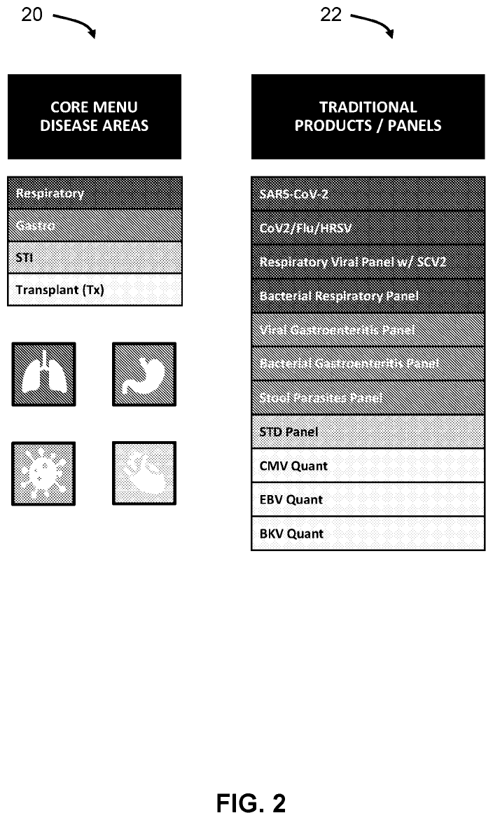

A conventional automated PCR testing system typically uses one or more test panels with multiple targets, such as a bacterial respiratory pathogens test panel, a viral gastroenteritis test panel, etc. Similar types of test panels are typically manufactured and distributed as a combined set of reagents, primers, enzymes, etc., and a test facility must run all the pathogens and targets covered by the full test panel together. FIG. 2 is a diagram showing an example of a menu screen with core disease areas 20 (left) and products and panels 22 found in a traditional automated PCR system (right), with multiple pathogens combined into particular testing panels. The left column of FIG. 2 shows core menu disease areas 20, which may include respiratory diseases, gastrointestinal diseases (“gastro”), sexually transmitted infections (STIs), and transplant or immunocompromised (Tx) conditions. The right column of FIG. 2 shows examples of traditional products or panels 22 that may be found within the core menu disease areas. There may also be certain cases with individual targets that can be tested in a traditional PCR test, such as testing for the SARS-CoV-2 virus. While the use of multi-target panels can offer some benefits in terms of testing for more than one pathogen that may have similar behaviors, they do not provide flexibility or choice in choosing flexible and customized testing, and require larger amounts of patient samples to be used for testing targets that may not be needed or desired by a patient's physician or healthcare provider. If individual targets that occur in different panels need to be tested, there may not be enough patient sample volume given the requirements of the full testing panel procedures. In a conventional PCR testing system, there is little or no ability to perform PCR tests for specific individual targets with random and on demand access.

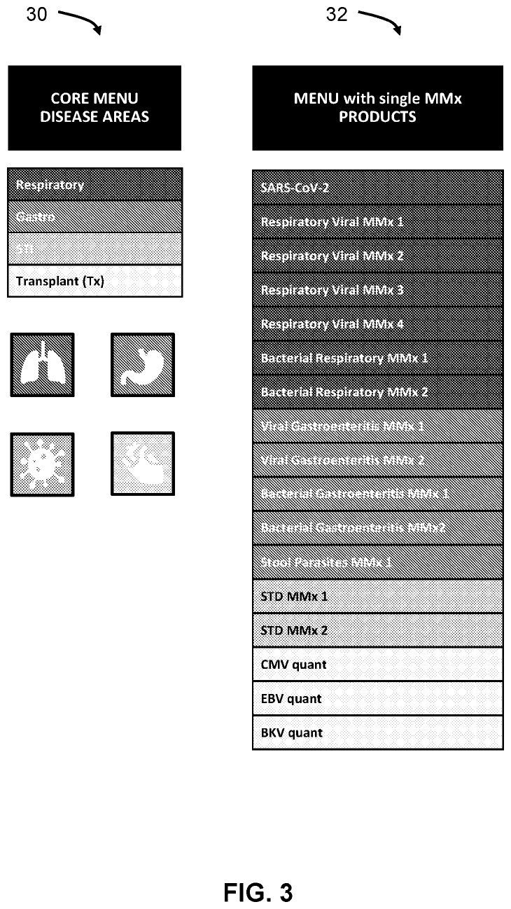

In the pick-and-mix PCR strategy of the present embodiments, there is a wider variety of master mixes (MMx) that provide greater flexibility of choosing particular targets or pathogens and assays. FIG. 3 is a diagram showing an example of a menu screen with core areas 30 (left) and targets in a pick-and-mix PCR strategy system 32 (right), with the option to choose single targets or some panels with multiple targets, according to aspects of the present embodiments. The core menu disease areas 30 in the left column of FIG. 3 are the same as the ones in FIG. 2. That is, the basic idea of initially grouping testing by affected patient systems or general types of symptoms remains the same. This grouping of testing may be considered syndromic testing. However, in the pick-and-mix PCR strategy, the menu on the right column of FIG. 3 contains multiple single targets and multiple-target master mixes with a smaller number of target pathogens. Thus, it will be possible to have greater flexibility including customization of requests in picking and mixing different master mixes and targets for a PCR test. In different embodiments of a pick-and-mix PCR strategy system, different individual master mixes with single or multiple targets may be implemented together. In some implementations, it may be possible to pre-load up to 50 master mixes each containing 1-5 targets, thus providing significantly more flexibility and choice in testing.

### Pathways for Master Mixes and Samples in Pick-and-Mix PCR Testing

Within the pick-and-mix PCR strategy, there are distinct pathways for both master mixes and patient samples. These pathways enable physical reagents and samples to be loaded, extracted, mixed, stored, combined, tested, harvested, and discarded. The master mix pathway produces master mix portions that are ready to be used in a PCR reaction, and the sample pathway produces eluate portions from a patient sample or control sample that are tested in the PCR reaction. In addition to these two main pathways, there is a further pathway to enable reflex PCR reactions for reflex testing.

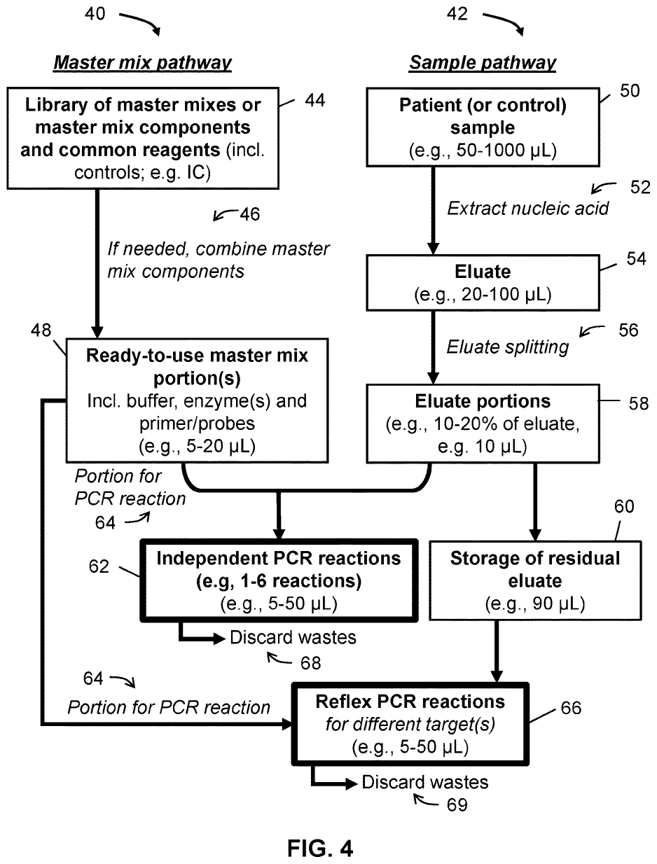

FIG. 4 is a flow chart diagram showing the movement of master mixes in a master mix pathway 40 (left) and of samples and eluates in a sample pathway 42 (right) in a pick-and-mix strategy system, with both master mixes and sample eluates coming together in multiple PCR reactions 62 (center), according to aspects of the present embodiments. In the master mix pathway 40, there may be a library of master mixes or master mix components and common reagents 44. In the next step 46, master mix components are combined if needed (i.e., depending on instructions relayed from the laboratory information system (LIS) based on physician orders or based on laboratory testing algorithms or testing interests) thereby resulting in portions that are ready for PCR reaction being formed. Step 46 results in ready-to-use master mix portion(s) 48, which may include a buffer, enzyme(s), and primer/probe pairs. In some embodiments, the volume of a ready-to-use master mix portion may be about 5-20 μL.

Referring still to FIG. 4, the sample pathway 42 includes a patient (or control) sample 50, which may have a volume of about 50-1000 μL. In general, the patient sample may be a blood sample, saliva sample, mucus sample, a cerebrospinal fluid sample, a plasma sample, a sputum sample, or a stool sample. Prior to entry to the sample pathway, all patient samples are individually loaded into the PCR system and barcoded so that they can be individually identified and located within a storage area of the PCR system. One or more automated sample handling devices such as robot graspers, motors, and/or automated pipettors may be used to move and manipulate the samples. In some embodiments, a control sample may include an internal control, a negative control, or a positive control. The internal control may be spiked into a sample at the beginning of the workflow and may be extracted. Once instructions for a particular sample are received from the LIS or based on laboratory testing algorithms, the required patient sample is processed to extract nucleic acids 52. Depending on the corresponding assays indicated by the LIS for PCR testing, the nucleic acids being extracted may be DNA and/or RNA. After the nucleic acid extraction step 52, an eluate 54 is formed, with a volume of about 20-100 μL. Next, eluate splitting 56 is performed, to produce eluate portions 58 that may be about 10-20% of the total eluate volume, resulting in eluate portions of 2-20 μL volume. Eluate portions may also be about 10 μL in volume. In some embodiments, 1-5 eluate portions may be formed. In some embodiments, more than 5 eluate portions may be formed.

Referring still to FIG. 4, the ready-to-use master mix portions 48 are combined in portions for PCR reactions 64 with eluate portions 58 to perform independent PCR reactions 62, where the total combined volume of a master mix portion and an eluate portion that is run in a PCR reaction may be about 5-50 μL. In some embodiments, 1-5 independent PCR reactions may be run. In some embodiments, more than 5 independent PCR reactions may be run. After the PCR reactions 62 are completed, wastes from the PCR test are discarded 68. The data recorded from the PCR test are transmitted to the LIS.

Further features in FIG. 4 include the storage of residual eluate 60 after forming eluate portions 58. The volume of residual eluate remaining after removal of the eluate portions for initial PCR testing depends on the volume of eluate portions. For example, if the eluate was 100 μL, and a 10% eluate portion of 10 μL was used for test, then the remaining 90% or 90 μL eluate may be stored. The pick-and-mix PCR strategy is designed to make use of the stored remaining eluate for reflex testing. Following review of initial PCR test results, a medical provider may request further testing. Furthermore, lab specific testing algorithms or needs may automatically trigger reflex testing. Reflex PCR reactions 66 in the pick-and-mix PCR system may use a portion of the stored eluate 60 combined with another portion 64 of the ready-to-use master mixes 48. The reflex PCR reactions 66 may be for different targets, and may have combined reaction volumes of about 5-50 μL. After the reflex reaction 66 is complete, wastes are discarded 69.

The samples moving along the sample pathway 42 of FIG. 4 may also include positive control (PC) samples, negative control (NC) samples, and internal control (IC) samples. These control samples may be spiked into the patient test samples, or they may be run on their own. The PC samples (which are normally run on their own at a specific frequency, e.g., once per day) are used to confirm that the PCR system and assays are operating correctly. The NC samples (which are also normally run on their own at a specific frequency; e.g., once per day) are used to confirm that no cross-contamination of nucleic acids has occurred. The IC samples (which are normally spiked into all samples and controls) are used to confirm that all aspects of the test system are correctly functioning. Calibrators (another type of control sample) are run on their own either as a sample (with extraction and PCR) or only as PCR to quantify the concentrations of unknown samples.

### Pick-and-Mix PCR Testing Procedures

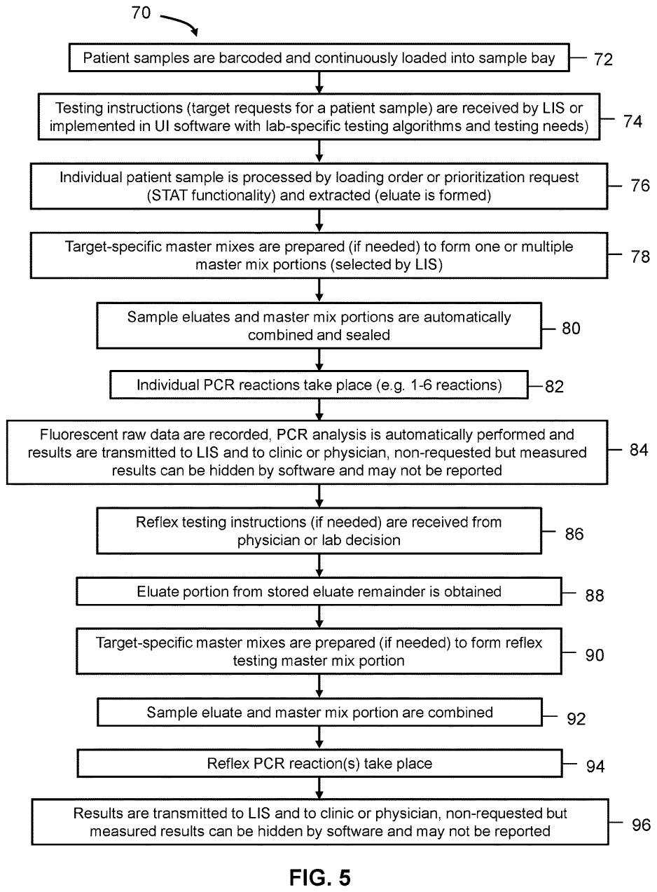

In this section, an example PCR testing procedure in the pick-and-mix PCR strategy is described. FIG. 5 is a flow chart diagram showing a method 70 for performing an analysis using a pick-and-mix strategy PCR system, according to aspects of the present embodiments. In step 72, patient samples are barcoded and continuously loaded into the sample bay of the PCR system. In step 74, testing instructions are entered into the LIS. The testing instructions may be received by the LIS via electronic communications from a physician or medical provider, or may be entered by an operator or user of the PCR system into the PCR system's software user interface (UI) with laboratory-specific testing algorithms and testing needs. The instructions may include target requests (i.e., specific target pathogen(s) to detect), and specific patient sample(s) loaded in step 72. During this step, many targets and many samples may be instructed for further PCR testing. In step 76, an individual patient sample is processed by loading order or prioritization request (i.e., STAT functionality), and extracted to form an eluate. During this step, the selection of sample is coordinated by the LIS based on clinical instructions and laboratory-specific testing algorithms. STAT testing is triggered by the PCR system software UI which can be assigned to one or several samples by the operator to any sample loaded to the system. Non-STAT samples are then processed until a useful holding step to allow workflow prioritization for STAT samples without losing other samples. The extraction of nucleic acids may involve different specific steps and reagents depending on the type of patient sample and type of nucleic acid, but in general may include steps of forming a lysate, clearing of the lysate, binding to a purification matrix, washing, and eluting the nucleic acids from the matrix to obtain purified nucleic acid in the eluate.

Referring still to FIG. 5, in step 78, target-specific master mixes are prepared (if needed) to form one or multiple master mix portions, based on the random on-demand access selections determined by the LIS or laboratory-specific testing algorithms. The preparation of master mixes may include measuring, pipetting, dispensing, mixing, and transferring reagents using various automated pipettors, robot arms, actuators, etc. In step 80, sample eluates (formed in step 76) and master mix portions (formed in step 78) are automatically combined and sealed to prepare for PCR reactions. In step 82, individual PCR reactions take place. During individual PCR reactions, the combined sample eluates and master mix portions (from step 80) are subjected to particular heating cycle programs as determined by the needs of the particular targets and assays in use in each PCR reaction, as instructed by the LIS or laboratory-specific testing algorithms. The heating cycle programs may include various combinations of temperatures, heating rates, and heating times. Each PCR slot or well may be temperature-controlled separately which allows maximum flexibility to combine different master mixes with different cycling profiles for optimal analytical assay performance. In step 84, fluorescent raw data are recorded, PCR analysis is automatically performed, and results are transmitted to the LIS and subsequently transmitted to a clinic or physician or other medical provider who may be involved with patient care. Any non-requested but measured results (e.g., targets that may be included in a multi-target mix) can be optionally hidden by the system software and may not be reported to LIS. Data from laboratory testing algorithms or needs which are not covered by LIS can be stored and analyzed on the system or in a laboratory database.

Referring still to FIG. 5, in step 86, if reflex testing is needed, instructions for reflex testing are received by the LIS from a physician and/or a lab decision or testing algorithm based on analysis of the initial PCR results transmitted in step 84. Examples of reflex testing include testing for other pathogens (e.g., bacteria) that may cause gastrointestinal disease after a first set of tests for common gastrointestinal pathogens (e.g., viruses) were negative, or further testing to identify a specific variant, subtype, or species of a pathogen identified in a first test (e.g., SARS-CoV-2 variant testing after generic positive SARS-CoV-2 result), etc. In step 88, an eluate portion from the stored eluate remainder is obtained. In step 90, target-specific master mixes are prepared (if needed) to form a reflex testing master mix portion. In step 92, the sample eluate and master mix portion are combined. In step 94, one or more reflex PCR reaction(s) take place. The results of the reflex testing are then reported via the LIS to the physician or clinic 96. Tests that are not requested by the LIS but measured can be optionally hidden by the system software and may not be reported to LIS. Data from laboratory testing algorithms or testing needs which are not covered by the LIS may be stored and analyzed on the system or in a laboratory database for potential future use.

After the results of the testing are reported 96 at the end of the method 70, the results may be used to provide a diagnosis to a patient. Furthermore, methods according to the present embodiments may include one or more treatment steps that include one or more suitable treatments, once a diagnosis has been made, as described herein.

### Pick-and-Mix PCR System Components

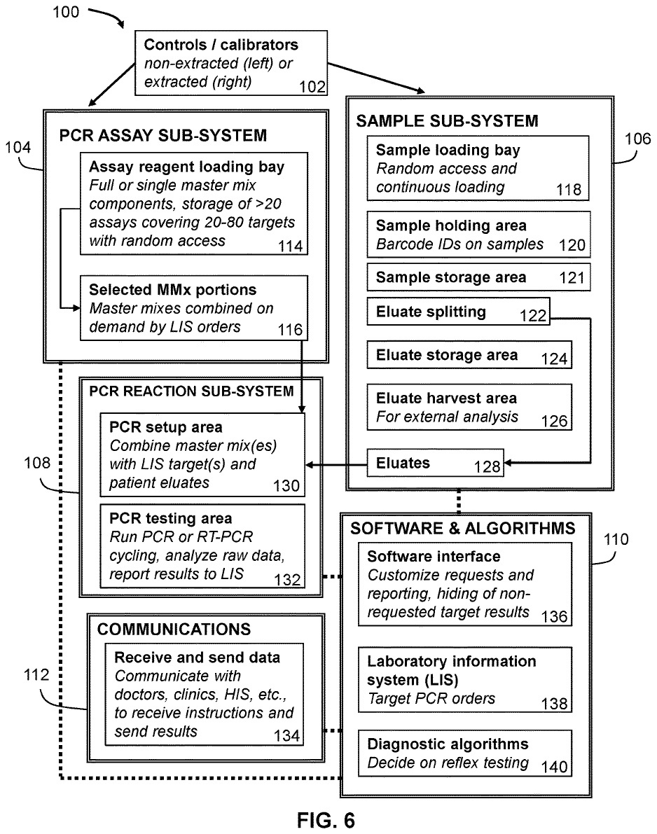

FIG. 6 is a diagram showing main components of a pick-and-mix PCR system 100, how they relate to each other, their constituent sub-components, and how some sub-components relate to each other, according to aspects of the present embodiments. In some embodiments, the main sub-systems may include the PCR assay sub-system 104, the sample sub-system 106, the PCR reaction sub-system 108, the software and algorithms sub-system 110, and the communications sub-system 112.

Referring still to FIG. 6, the PCR assay sub-system 104 may include an assay reagent loading bay 114 and selected master mix portions 116. In the assay reagent loading bay 114, full or single master mix components may be loaded, and there may be storage of over 20 assays covering approximately 20-80 targets with random access. In the selected master mix portions 116, master mixes may be combined on demand by LIS orders. The selected master mix portions 116 may be formed from the components in the assay reagent loading bay 114. Furthermore, in FIG. 6, the sample sub-system 106 may include a sample loading bay 118 that may accommodate random access and continuous loading of patient samples, a sample holding area 120 which may include mechanisms for applying and/or reading barcode IDs on samples, eluate splitting 122 functions, an eluate storage area 124, an eluate harvest area 126, which may include mechanisms to use eluates for external analysis, and a plurality of sample eluates 128. The PCR reaction sub-system 108 illustrated in FIG. 6 may include a PCR setup area 130, in which one or more master mixes may be combined with LIS target(s) and patient eluates. In this PCR setup area 130, the selected master mix portions 116 come from the PCR assay sub-system 104 and the eluates 128 come from the sample sub-system 106. The PCR reaction sub-system 108 may also include a PCR testing area 132 in which PCR or RT-PCR cycling may occur, along with analyzing raw data, and reporting results to the LIS. The PCR or RT-PCR thermal cycling occurs in one or more PCR thermal cycler modules, which may have shared or independent temperature control and cycling capabilities. The PCR testing area 132 may also include a PCR well sealing unit to avoid contamination after a PCR run.

The software and algorithms subsystem 110 illustrated in FIG. 6 may include a software interface 136 that may handle customizing of requests and reporting, and hiding (i.e., not reporting) of non-requested results, and other interactions with a user or operator of the PCR system. The software and algorithms subsystem 110 may be used to program, control, and run flexible and customized diagnostic workflows. The software and algorithms subsystem 110 may also include a laboratory information system (LIS) 138 that is responsible for handling target PCR orders, and diagnostic algorithms 140 that may make decisions and/or suggestions or recommendations on whether reflex testing should be performed. The software and algorithms subsystem 110 may also include laboratory-specific testing algorithms and testing needs which can be customized and defined in the system software. The communications sub-system 112 may include mechanisms to receive and send data 134, which involves communications with medical providers such as doctors, clinics, HIS (hospital information systems), and/or other entities in order to receive instructions and send test results. New instructions from the medical providers or laboratory-specific testing algorithms may include additional test targets based on initial test results, i.e., reflex testing instructions.

### Comparison of Conventional PCR and Pick-and-Mix PCR

### Reagents

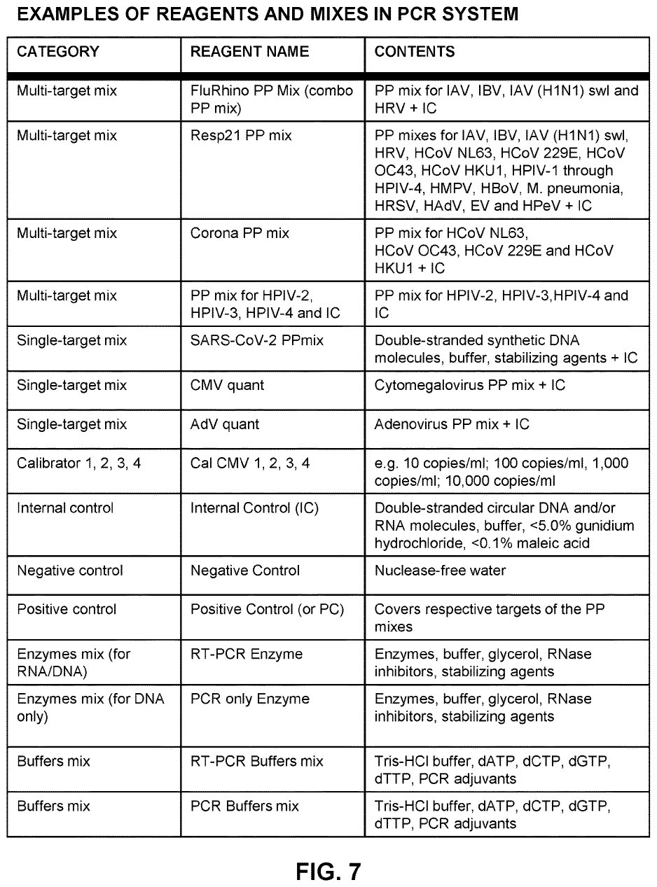

The reagents and mixes used in conventional PCR systems and the pick-and-mix PCR system of the present embodiments may differ in the combinations of targets and/or other reagents. FIG. 7 is a table showing examples of different types of multi-target mixes, single-target mixes, calibrators, control samples (i.e., IC, PC, NC), enzymes, and buffers that may be used in a pick-and-mix PCR system, according to aspects of the present embodiments. In some embodiments, a multi-target mix may contain primer/probe mixes (PP mixes) for multiple pathogen targets together, along with primer/probes for internal and positive controls and other chemical agents needed for the reaction. A single-target mix may include primers and probes amplifying the DNA or RNA targeting a single pathogen, along with internal controls and other needed chemicals. Other categories of components may include calibrations for different known target concentrations, internal controls, negative controls, positive controls, enzymes for DNA or RNA for PCR or RT-PCR, and buffers. In some embodiments of a pick-and-mix PCR system, multiple examples of reagents and/or mixtures across categories may be included in the system so that different PCR test mixtures may be formed on demand as needed.

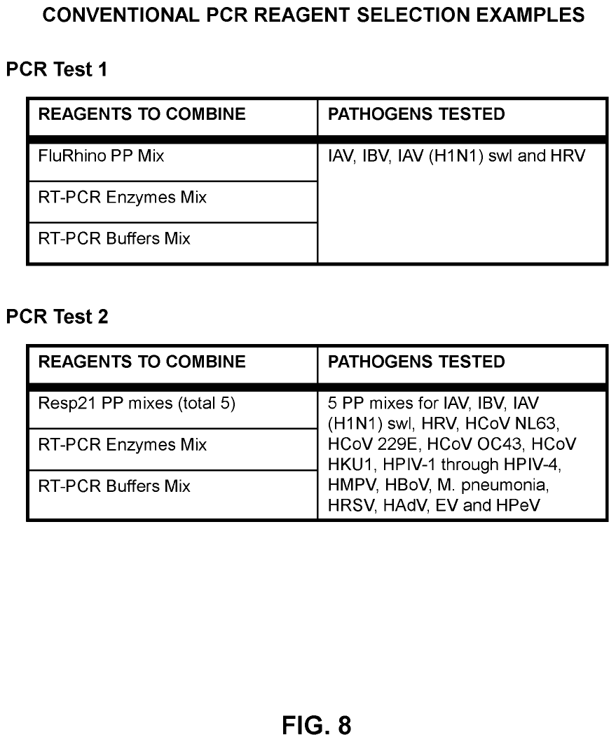

FIG. 8 includes two tables showing two examples of PCR tests (i.e., kits or products) and reagents to be combined in a conventional PCR testing system, where multiple targets must be tested at the same time. These examples are illustrative of some embodiments of combining assays using commonly available multi-target master mixes used for current automated PCR systems; there may be many other combinations of assays possible during operation of an automated PCR system. In the example PCR Test 1 shown in FIG. 8, a commonly used mixture known as a FluRhino PP Mix, which tests for influenza A virus (IAV), influenza B virus (IBV), H1N1 flu virus, and human rhinovirus (HRV), is combined with enzymes and buffers used in RT-PCR reactions. In example PCR Test 2 shown in FIG. 8, a commonly used mixture known as Resp21 PP mix tests for the same viruses in Test 1, but also tests for additional pathogens that may cause respiratory viruses including human coronaviruses (HCoVs), human parainfluenza viruses (HPIVs), human metapneumovirus (HMPV), human bocavirus (HBoV), Mycoplasma pneumonia (M. pneumonia) bacteria, human respiratory syncytial virus (HRSV), human adenoviruses (HAdV), enteroviruses (EVs), and human parechoviruses (HPeVs). Enzymes and buffers used for RT-PCR are also included in the reagents to be combined. In conventional PCR workflows, PCR test 1 (which may be a kit or a product) might be applied for testing patient samples which are then found to be negative for all targets. This result may trigger a second test, PCR test 2 (which may be a second kit or product) which may screen for a larger selection of pathogens but would duplicate testing for targets already contained in PCR test 1.

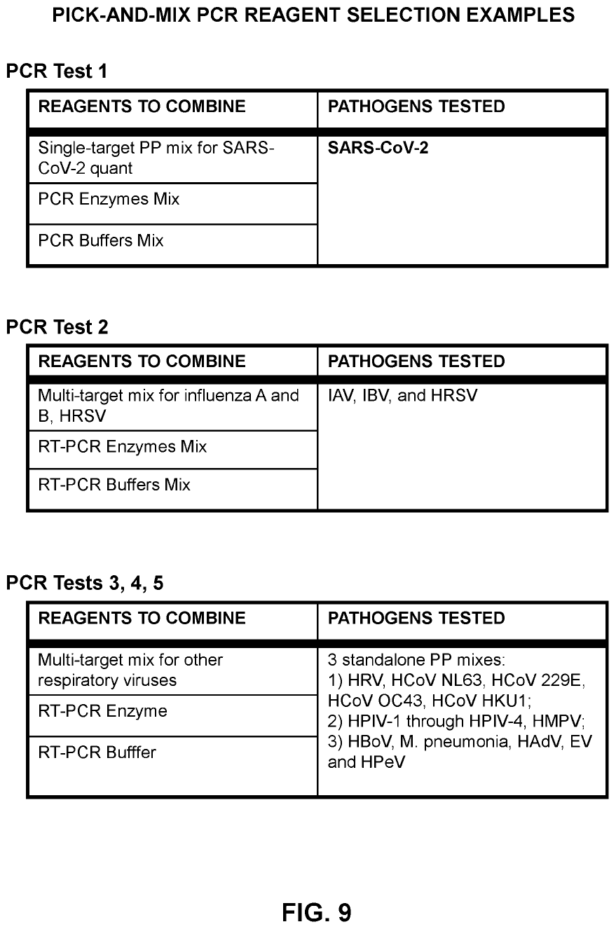

FIG. 9 includes three tables showing three examples of PCR tests (i.e., kits or products) and reagents to be combined in a pick-and-mix PCR testing system, where a combination of single-target and multi-target (master) mixes can be chosen, according to aspects of the present embodiments. These examples are illustrative of some embodiments of combining single-target and multi-target master mixes for use in a new pick-and-mix strategy PCR system; there may be many other combinations of assays possible during operation of a pick-and-mix strategy PCR system. In example PCR Test 1, a single-target primer/probe mix for quantitative PCR of SARS-CoV-2 is combined with enzymes and buffers for PCR reaction. This mixing can happen off or on system. In some embodiments, the system may combine a ready to use master mix by adding one or two more components, such as a buffer and enzymes, which are also preloaded on the system. In some embodiments, mixing of components may occur off system and be loaded together into the system to be used if the pre-mixed combination or product is sufficiently stable. In example PCR Test 2, a multi-target mix for influenza A, influenza B, and HRSV (human respiratory syncytial virus) is combined with a multi-target primer/probe mix for all three viruses together with enzymes and buffers for RT-PCR, which may be combined on or off system. In example PCR Tests 3, 4, and 5, a multi-target primer/probe mix that tests for additional respiratory viruses and coronavirus subtyping is combined with enzymes and buffers for RT-PCR on or off system.

Syndromic workflows as described herein can be chosen with flexibility, and multiple iterations or combinations of primary testing and reflex testing can be designed and executed on the system as specific workflows. In one example, patient samples may be extracted and eluates may be split into five portions and all five PCR tests may be run simultaneously. In another example, patient samples may be extracted and tested only for PCR test 1 or PCR test 1 and 2 using two eluate portions. In that example, if all targets are not detected, leftover eluates from a first extraction or eluate from an independent second sample extraction from the same patients may be tested sequentially or combined with PCR tests 3, 4, and/or 5. Multiple iterations of primary and/or reflex testing can be implemented in this system by choosing the relevant master mixes and testing on either freshly extracted eluates or stored eluates in a reflex mode. In general, the pick-and-mix PCR testing strategy enables greater flexibility of choosing targets to test at the same time than conventional PCR testing, and provides faster turnaround times. Because the assay components are stored as separate source components, including components needed to test for separate single targets as well as multi-target panels, they can be selected and combined with each other in different configurations and testing orders or sequences based on the needs of the patient and the instructions of the medical provider. Testing is not restricted to the commonly available multi-target panels, that may combine up to 20 targets together, some of which may not be clinically relevant but are required to be tested at the same time and thus use up the patient sample volume without necessarily providing useful results. The commonly available multi-target panels are often used in so-called molecular point of care systems or cartridges with fixed panel size and content, and thus do not offer flexibility. In contrast, in the pick-and-mix PCR strategy, by splitting larger PCR tests (or kits or products) into smaller flexible PCR tests (or kits or products) containing only one master mix with one to several targets or pathogens, tests can be combined at will, on demand, and with random access in different workflow and testing scenarios.

### Testing Procedures and Workflows

The workflow of a conventional PCR testing system and the pick-and-mix PCR system have some similarities, but main differences include the ability to combine test targets and what samples are used for reflex testing.

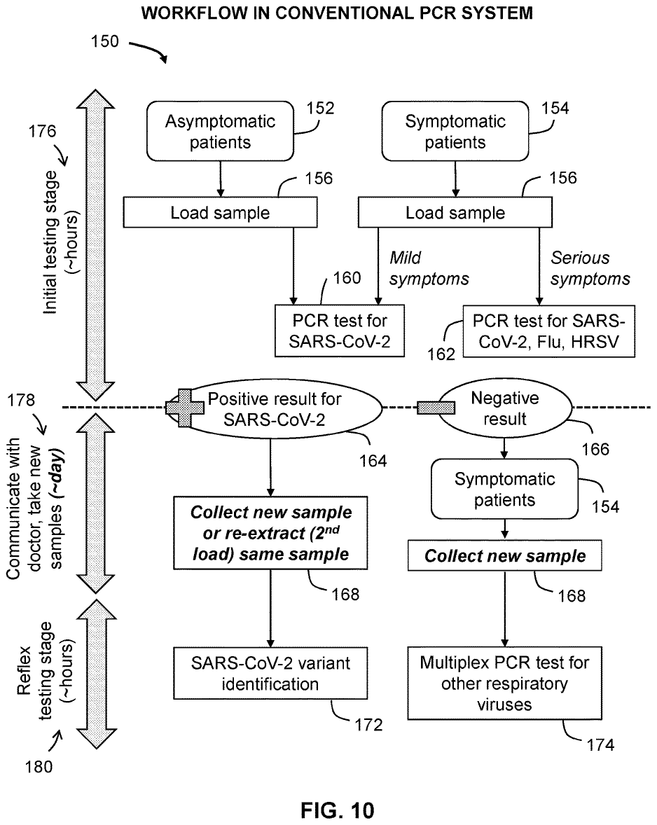

FIG. 10 is a flow chart diagram showing an example of a workflow 150 and time estimate for a conventional PCR testing system. After an initial testing stage 176, taking new patient samples (or second extraction from leftover sample) is required if reflex testing is ordered. In the initial testing stage 176, which may take time on the order of hours, samples are loaded into the system (step 156) from either asymptomatic patients 152 or symptomatic patients 154. Samples from asymptomatic patients 152 or symptomatic patients 154 with mild symptoms are subjected to PCR testing 160 for SARS-CoV-2. Symptomatic patients 154 with serious symptoms are subjected to PCR testing for a multiplex PCR test with SARS-CoV-2, influenza (often type A and B), and HRSV 162. If there is a positive result for SARS-CoV-2 164 from any of the tests 160, or 162, then the testing for SARS-CoV-2 variants might be of interest. If the sample was negative for SARS-CoV-2, influenza (A/B) and HRSV, a downstream test for additional respiratory viruses may be requested. In both cases a new sample may be collected and loaded or, if possible, the same leftover sample maybe extracted again 168. This stage of the workflow (178) involves communicating with a doctor and possibly taking new patient samples, and may take additional time, on the order of about a day and possibly longer. If there is leftover sample from the same patient, the sample may be loaded and extracted again 168, which adds preparation and extraction time and costs. In some instances, for example with a negative result 166 in symptomatic patients, a new patient sample may be collected 168. During the reflex testing stage 180, a positive result may lead to testing for identification of a certain SARS-CoV-2 variant, while a negative result may lead to multiplex PCR testing for other viruses. Due to the requirement to communicate with a doctor and obtain new samples 178 for reflex testing, the total workflow time may be at least several hours if not about a day, and possibly longer.

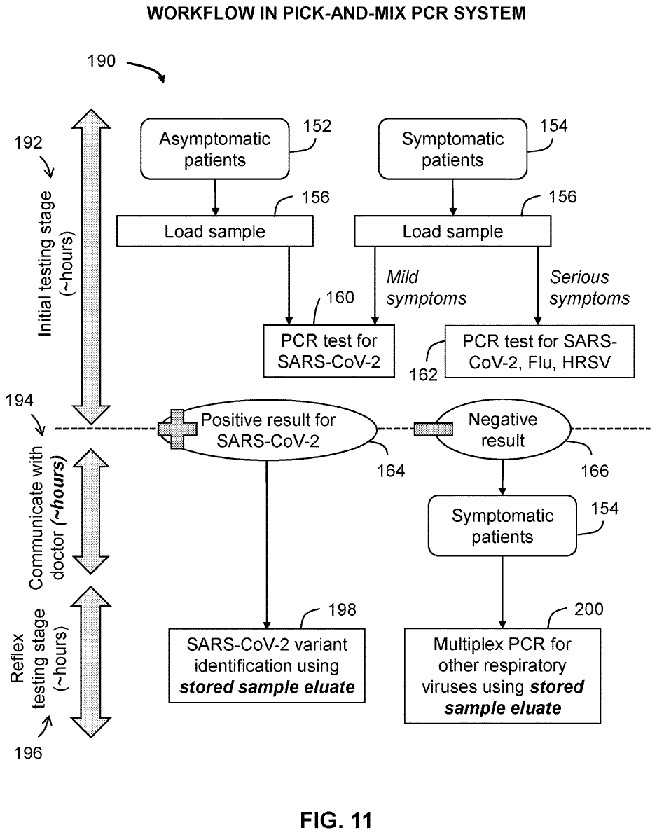

FIG. 11 is a flow chart diagram showing an example of a workflow 190 and time estimate for a pick-and-mix PCR system. After an initial testing stage 192, stored sample eluates can be used immediately for reflex testing, according to aspects of the present embodiments. In the initial testing stage 192, which may take time on the order of hours, samples are loaded 156 from either asymptomatic patients 152 or symptomatic patients 154. The samples from asymptomatic patients 152 and from symptomatic patients 154 with mild symptoms may be subjected to PCR testing for SARS-CoV-2 160. Samples from symptomatic patients 154 with serious symptoms may be subjected to PCR testing for SARS-CoV-2, influenza A and B, and HRSV 162. In the next stage 194, communication with a doctor and deciding on reflex testing may take time on the order of hours. If there is a positive result 164, reflex testing can immediately take place to identify a SARS-CoV-2 variant 198, using stored sample eluate. If there is a negative result 166, for symptomatic patients 154, reflex testing may involve multiplex PCR testing 200 for other viruses using stored sample eluate. The reflex testing stage 196 may take time on the order of 1 hour (i.e., for just the PCR run time without extraction). Due to the use of stored sample eluates, the total workflow time may be on the order of a few hours. Compared to the conventional PCR workflow 150, stage 194 may be much shorter than stage 178, especially if a new sample needs to be taken by the physician and sent to the lab.

### Control and Communication Procedures

In some embodiments, the present disclosure provides methods for a user interface (UI) to provide instructions to a user and receive inputs from a user.

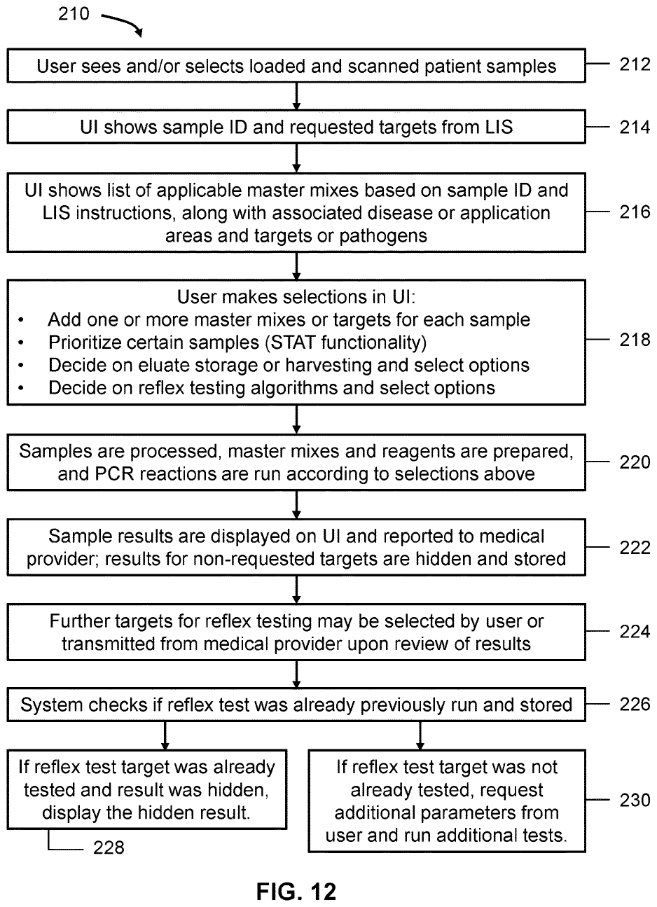

FIG. 12 is a flow chart diagram showing a method 210 for a user to interact with a user interface (UI) to provide inputs to, and receive outputs from, a software program controlling a pick-and-mix PCR testing system, according to aspects of the present embodiments. This method 210 may be implemented by a user who may operate the pick-and-mix PCR testing system. Prior to step 212, one or more patient samples may be loaded into the PCR testing system, by the user or by other operators. In step 212, the user may see displayed in the UI the available patient samples that have been loaded and scanned. The user may then select one or more of the patient samples. In step 214, the UI may show the sample ID and requested targets from the LIS or laboratory-specific testing algorithms or needs. The LIS or laboratory-specific testing algorithms may include instructions from a doctor, clinic, and/or other medical provider for testing.

Referring still to FIG. 12, in step 216, the UI may show a comprehensive list of applicable master mixes based on the sample ID and LIS instructions, along with associated disease or application areas and targets or pathogens. In steps 214 and 216, the UI shows sample ID and requested targets from the LIS (“proposed testing”). The UI also gives access to the available testing master mixes on the system. In step 218, the user may review and confirm the proposed testing or makes selections or adjustments in the UI that may include: adding one or more master mixes or targets for each sample; prioritizing certain samples (i.e., STAT functionality); deciding on eluate storage or harvesting and selecting options; and deciding on reflex testing algorithms and selecting options. In this step, the user may have significant flexibility in tailoring the parameters of the PCR testing. In step 220, samples may be processed, master mixes and reagents may be prepared, and PCR reactions may be run, according to the selections made above in step 218. In step 222, sample results may be displayed on the UI and reported to the user, while hiding some results that may have been tested as part of a master mix but not initially requested. In step 224, the user may choose further reflex testing and reporting to the clinic or physician. The reporting to the clinic or physician may then lead to additional instructions or requests for more reflex testing. In step 226, the systems checks if the reflex test was previously run and stored (step 222). If a reflex testing target may have been already tested and the result was previously hidden, then the UI may display the result in step 228, and transmit the result to the clinic or physician or other medical provider. If the reflex test target was not previously tested, then the UI may request additional parameters from the user and then run additional PCR tests based on the user inputs in step 230, and then communicate the results to the clinic or physician or other medical provider.

### EQUIVALENTS

Those skilled in the art will recognize, or be able to ascertain using no more than routine experimentation, many equivalents to the specific embodiments of the invention described herein. The scope of the present invention is not intended to be limited to the above Description, but rather is as set forth in the following claims:

What is claimed is:

1. An automated system for performing real-time polymerase chain reaction (PCR) assays with random access, comprising:
a random access sample sub-system;
a random access PCR assay sub-system;
a PCR reaction sub-system; and
a software and control system to program, control and run diagnostic workflows.

2. The automated system of claim 1, wherein the random access sample sub-system comprises:
a sample loading bay through which a plurality of patient samples are introduced into the automated system;
a sample holding area adjacent to the sample loading bay;
a lysis module adjacent to the sample holding area;
a plurality of sample extraction slots adjacent to the sample holding area to extract nucleic acids from the plurality of patient samples;
a temperature-controlled sample storage tower adjacent to the plurality of sample extraction slots to store the patient samples;
an eluate harvest area;
an eluate splitting mechanism;
a temperature-controlled eluate storage tower to store eluates harvested in the eluate harvest area; and
an automated transport module to move samples and eluates between each of the sample loading bay, the sample holding area, the sample extraction slots, the sample storage tower, the eluate splitting mechanism, the eluate harvest area, and the eluate storage tower.

3. The automated system of claim 1, wherein the random access PCR assay sub-system comprises:
an assay reagent and PCR master mix loading bay through which assay reagents and PCR master mixes are introduced into the automated system;
a plurality of assay reagent storage slots adjacent to the assay reagent and PCR master mix loading bay;
a plurality of PCR master mix storage slots adjacent to the assay reagent and PCR master mix loading bay;
an automated assay transport module to transfer assays and master mixes between different components of the PCR assay sub-system; and
an automated multichannel pipettor.

4. The automated system of claim 1, wherein the PCR reaction sub-system comprises:
a PCR setup area to combine and prepare PCR testing components;
a PCR testing area adjacent to the PCR setup area; and
an automated multichannel pipettor.

5. The automated system of claim 4, wherein the PCR testing area comprises:
a plurality of centrifuge modules;
a plurality of real-time thermal cycler modules; and
a PCR well sealing unit.

6. The automated system of claim 1, wherein the software and control system comprises:
a computer processor and a memory system;
a communications connection;
a laboratory information system (LIS); and
a digital user interface (UI),
wherein the computer processor executes programs stored in the memory system to select samples and assays for conducting PCR testing and to report PCR test results,
wherein the computer processor controls the digital UI to interact with a user to program and run customized testing workflows,
wherein the communications connection receives instructions for conducting PCR testing and transmits PCR test results, and
wherein the computer processor, the memory system, the communications connection, and the digital user interface are all electronically coupled.

7. The automated system of claim 6, wherein the communications connection comprises a wired internet connection and/or a wireless internet connection, and wherein the communications connection receives test instructions from a medical provider and transmits test results to the medical provider.

8. The automated system of claim 1, wherein the system further comprises:
a software-based user interface; and
diagnostic algorithms to assess test results and select reflex testing.

9. A method for performing random access polymerase chain reaction (PCR) testing by an automated system, comprising:
receiving, by a laboratory information system (LIS) in the automated system, PCR testing instructions from a medical provider;
preparing one or more patient test samples as instructed by the testing instructions;
preparing one or more master mix portions from subcomponents as instructed by the testing instructions;
performing one or more PCR tests using a combined test volume comprising the one or more patient test sample and the one or more master mix portions;
obtaining results from the one or more PCR tests; and
communicating the results.

10. The method of claim 9, wherein preparing the one or more patient test samples comprises:
selecting a patient sample obtained from a patient;
extracting nucleic acids from the patient sample;
preparing one or more eluates to form the one or more patient test samples; and
storing additional eluates in an eluate storage area of the automated system.

11. The method of claim 9, wherein preparing one or more master mix portions comprises:
selecting one or more target-specific master mixes from a plurality of PCR master mixes stored in the automated system, the one or more master mix portions being determined from the PCR testing instructions;
obtaining one or more quantities of the one or more target-specific master mixes using an automated mechanism; and
forming the one or more master mix portions by combining the following:
one or more quantities of the one or more target-specific master mixes; and
one or more other reagents selected from the group consisting of PCR enzymes, PCR buffers, and control samples.

12. The method of claim 9, wherein performing one or more PCR tests comprises:
combining and sealing the one or more patient test samples and one or more master mix portions to form one or more test volumes;
transferring the one or more test volumes to one or more thermal cyclers; and
operating the one or more thermal cyclers as instructed by a thermal program provided by the LIS based on the testing instructions.

13. The method of claim 9, wherein obtaining results from the one or more PCR tests comprises:
measuring one or more optical signals from the one or more test volumes during the one or more PCR tests; and
storing the one or more optical signals as one or more test results in a memory system of the automated system,
wherein the one or more optical signals comprise one or more fluorescent signals.

14. The method of claim 9, wherein communicating the results comprises:
for each target tested in the one or more master mix portions,
checking whether the target was requested in the test instructions from the medical provider;
if the target was requested, displaying the result to an operator of the automated system and transmitting the result to the medical provider; and
if the target was not requested, continuing to store the test result in the memory system of the automated system.

15. The method of claim 9, wherein the method prior to preparing the one or more patient test samples comprises:
applying a barcode to each of a plurality of biological samples obtained from patients;
loading each of the plurality of biological samples into the automated system; and
processing each of the plurality of biological samples by loading order or by a prioritization request received by the LIS.

16. The method of claim 2, wherein the method further comprises receiving reflex testing instructions from the medical provider after communicating the results to the medical provider.

17. The method of 16, wherein the method further comprises the following steps to conduct reflex testing:
checking whether a reflex test target has previously been tested and has been stored in memory;
displaying and communicating the previously tested result if the result is available;
obtaining a sample eluate from previously stored sample eluates;
preparing one or more master mix portions;
performing one or more reflex PCR tests as instructed by the reflex testing instructions; and
communicating results from the one or more reflex PCR tests.

18. A method of a user interacting with a random access PCR test system to perform a PCR test, comprising:
(a) selecting, by the user, a patient sample using a user interface (UI) associated with the random access PCR test system;
(b) viewing on the UI, by the user, instructions transmitted by a medical provider to a library information system (LIS);
(c) selecting via the UI, by the user, testing parameters for one or more PCR tests, wherein the testing parameters are based on the instructions;
(d) preparing, by the PCR test system, the patient sample and one or more master mix portions determined by the instructions so that the patient sample and the one or more master mix portions are combined for PCR testing;
(e) running, by the PCR test system, one or more PCR tests;
(f) displaying, by the PCR test system, the result of the one or more PCR tests on the UI;
(g) selecting, by the user using the UI, further reflex testing instructions and/or reporting the results to the medical provider;
(h) displaying, by the PCR system on the UI, any requested results that may have been previously hidden;
(i) preparing, by the PCR test system, a sample from a stored sample eluate from the same patient sample and one or more master mix portions as indicated by reflex testing instructions from step (g); and
(j) running, by the PCR test system, one or more PCR tests as indicated by reflex testing instructions from step (g).

19. The method of claim 18, wherein selecting test parameters comprises:
adding one or more master mixes or targets corresponding to the instructions;
setting sample priority level;
deciding on storage or harvesting of eluate; and
deciding on reflex testing algorithms and options.

20. The method of claim 18, wherein running one or more PCR tests comprises:
(a) heating a sample and one or more master mixes to a denaturation temperature at a first heating rate and holding at the denaturation temperature for a first time period;
(b) cooling the sample and the one or more master mixes to an annealing temperature at a first cooling rate and holding at the annealing temperature for a second time period;
(c) heating the sample and the one or more master mixes to an extension temperature and holding at the extension temperature for a third time period; and
(d) repeating steps (a)-(c) for a required number of cycles.

21. The method of claim 20, further comprising activating the sample via Taq polymerase heat activation prior to step (a).

22. The method of claim 20, further comprising performing a reverse transcriptase (RT) step for RNA targets prior to step (a).
